(19) United States
(12) Patent Application Publication
(10) Pub. No.: US 2022/0335541 A1
(43) Pub. Date: Oct. 20, 2022

(54) SYSTEMS, METHODS, COMPUTING PLATFORMS, AND STORAGE MEDIA FOR PROFILE MATCHING

(71) Applicants: Armando Lopez, JR., Henderson, NV (US); Timothy Ball, Nagoya (JP); Ariel Guzman, Las Vegas, NV (US)

(72) Inventors: Armando Lopez, JR., Henderson, NV (US); Timothy Ball, Nagoya (JP); Ariel Guzman, Las Vegas, NV (US)

(21) Appl. No.: 17/715,356

(22) Filed: Apr. 7, 2022

Related U.S. Application Data
(60) Provisional application No. 63/175,136, filed on Apr. 15, 2021.

(51) Int. Cl. G06Q 50/00

(52) U.S. Cl. CPC G06Q 50/01

(57) ABSTRACT

Systems, methods, computing platforms, and storage media for profile matching are disclosed. Exemplary implementations may: receive a plurality of images from one or more sources; receive, via a first user device, a first request for profile matching from a first user; display, on the first user device, at least a portion of the plurality of images; receive, from the first user device, a first user input comprising one or more first preference indications for at least the portion of the plurality of images; determine an overlap between the first preference indications and one or more second preference indications received from a second user device; and in response to determining the overlap between the first and second preference indications exceeds a threshold, automatically causing the first or the second user device to indicate a match between the first and the second user.

### FIELD OF THE DISCLOSURE

The present disclosure relates to systems, methods, computing platforms, and storage media for profile matching, and more particularly to a profile matching process system and method.

### BACKGROUND

Existing on-line dating systems suffer some deficiencies and are prone to misuse by users who have no intention of using the system for its intended purposes, which may include scamming, spamming, cyberbullying, to name a few examples. For instance, some dating apps allow users to swipe through other user's profiles based on physical attraction. Such dating apps are common ground for “catfishing”, which is a term used when a person associated with a genuine online profile is lured into meeting someone or being in a relationship with someone associated with a fictitious online persona. A number of people have reported that the person they met from an online dating site was nothing like the person in the pictures, or was of a different gender, or did not come alone, etc. Safety issues aside, another problem associated with existing on-line dating systems is that it may be difficult for a user seeking a relationship to decide on a potential match based on one or two pictures of the potential match. In other words, making decisions based on a few pictures of another user is a poor way to match as it throws in people who are looking for genuine relationships or connections into a pool filled with users who are looking for casual encounters and/or users who are luring other users into adding them on other social media, such as INSTAGRAM, with no intention of using the app for its intended purpose. Some other dating apps allow users to create profiles and add in biographic information, likes/dislikes, answer a variety of questions to match users with other similar users, etc. One problem associated with using match questions to generate matches is that users often answer in a way that favors what they think people want to hear. Thus, existing techniques for profile matching on online dating sites or dating apps are lacking and help create an environment that makes it easy and profitable for users to troll, spam, and even scam other users.

### SUMMARY

Aspects of the current disclosure generally relate to a profile matching system utilizing a matching algorithm that receives as input user's selection of images (i.e., preference indications for a plurality of images displayed to the user) and computes a match value between two or more users as the output. In some examples, the images may be associated with various activities, places, food, fashion, interests, hobbies, etc., and may be sorted into one or more categories. A user may select or tap on an image of two or more images related to a category based on their preference. For instance, in one example the category may comprise: outdoor activity, and the user may be shown three images on their user device. The first image may be a stock image of a person skiing, the second image may be a stock image of a person working out at the gym, and the third image may be a stock image of a person riding a mountain bike along some trails. In this case, the selection of the mountain biking image vs skiing image or the gym image is a reflexive decision. In other words, it is not obvious to the user of what the best choice would be to attract someone. In this way, the user may select the image that appeals the best to them, since hobbies and preferences within a given category in life are very subjective. For example, two people might be equally into fitness, but one might prefer a short high intensity workout (e.g., the gym), whereas another might prefer a longer lower intensity workout like biking, or an activity with a social component to it, like skiing. This process of selecting (or tapping images) based on preferences within one or more categories may serve to create a barrier to entry. For instance, fake profiles that merely serve to divert legitimate users to an INSTAGRAM profile to attract followers may be worthless on such a system, since accounts that do not go through the tapping process described above may not generate matches. In other words, legitimate users may not come across accounts that are rarely active. Thus, scam users and fake profiles may automatically be filtered out of the dating platform due to their lack of activity.

One aspect of the present disclosure relates to a system configured for profile matching. The system may include one or more hardware processors configured by machine-readable instructions. The processor(s) may be configured to electronically receive, at one or more computer systems, a plurality of images from one or more sources. The processor(s) may be configured to electronically receive, via a first user device, a first request for profile matching from a first user. The processor(s) may be configured to display, on the first user device, at least a portion of the plurality of images. The plurality of images may be associated with one or more random categories. The processor(s) may be configured to receive, from the first user device, a first user input for at least the portion of the plurality of images. The first user input may include one or more first preference indications for at least the portion of the plurality of images. The processor(s) may be configured to compare, for at least the portion of the plurality of images, the one or more first preference indications to one or more second preference indications. The one or more second preference indications received from a second user device may be associated with a second user. The processor(s) may be configured to determine an overlap between the one or more first preference indications and the one or more second preference indications based at least in part on the comparing. The processor(s) may be configured to, in response to determining the overlap between the one or more first preference indications and the one or more second preference indications exceeds a threshold, automatically cause a graphical user interface associated with the first or the second user device to indicate a match between the first and the second user.

Another aspect of the present disclosure relates to a method for profile matching. The method may include electronically receiving, at one or more computer systems, a plurality of images from one or more sources. The method may include electronically receiving, via a first user device, a first request for profile matching from a first user. The method may include displaying, on the first user device, at least a portion of the plurality of images. The plurality of images may be associated with one or more random categories. The method may include receiving, from the first user device, a first user input for at least the portion of the plurality of images. The first user input may include one or more first preference indications for at least the portion of the plurality of images. The method may include comparing, for at least the portion of the plurality of images, the one or more first preference indications to one or more second preference indications. The one or more second preference indications received from a second user device may be associated with a second user. The method may include determining an overlap between the one or more first preference indications and the one or more second preference indications based at least in part on the comparing. The method may include, in response to determining the overlap between the one or more first preference indications and the one or more second preference indications exceeds a threshold, automatically causing a graphical user interface associated with the first or the second user device to indicate a match between the first and the second user.

Yet another aspect of the present disclosure relates to a computing platform configured for profile matching. The computing platform may include a non-transient computer-readable storage medium having executable instructions embodied thereon. The computing platform may include one or more hardware processors configured to execute the instructions. The processor(s) may execute the instructions to electronically receive, at one or more computer systems, a plurality of images from one or more sources. The processor(s) may execute the instructions to electronically receive, via a first user device, a first request for profile matching from a first user. The processor(s) may execute the instructions to display, on the first user device, at least a portion of the plurality of images. The plurality of images may be associated with one or more random categories. The processor(s) may execute the instructions to receive, from the first user device, a first user input for at least the portion of the plurality of images. The first user input may include one or more first preference indications for at least the portion of the plurality of images. The processor(s) may execute the instructions to compare, for at least the portion of the plurality of images, the one or more first preference indications to one or more second preference indications. The one or more second preference indications received from a second user device may be associated with a second user. The processor(s) may execute the instructions to determine an overlap between the one or more first preference indications and the one or more second preference indications based at least in part on the comparing. The processor(s) may execute the instructions to, in response to determining the overlap between the one or more first preference indications and the one or more second preference indications exceeds a threshold, automatically cause a graphical user interface associated with the first or the second user device to indicate a match between the first and the second user.

Still another aspect of the present disclosure relates to a system configured for profile matching. The system may include means for electronically receiving, at one or more computer systems, a plurality of images from one or more sources. The system may include means for electronically receiving, via a first user device, a first request for profile matching from a first user. The system may include means for displaying, on the first user device, at least a portion of the plurality of images. The plurality of images may be associated with one or more random categories. The system may include means for receiving, from the first user device, a first user input for at least the portion of the plurality of images. The first user input may include one or more first preference indications for at least the portion of the plurality of images. The system may include means for comparing, for at least the portion of the plurality of images, the one or more first preference indications to one or more second preference indications. The one or more second preference indications received from a second user device may be associated with a second user. The system may include means for determining an overlap between the one or more first preference indications and the one or more second preference indications based at least in part on the comparing. The system may include means for, in response to determining the overlap between the one or more first preference indications and the one or more second preference indications exceeds a threshold, automatically causing a graphical user interface associated with the first or the second user device to indicate a match between the first and the second user.

Even another aspect of the present disclosure relates to a non-transient computer-readable storage medium having instructions embodied thereon, the instructions being executable by one or more processors to perform a method for profile matching. The method may include electronically receiving, at one or more computer systems, a plurality of images from one or more sources. The method may include electronically receiving, via a first user device, a first request for profile matching from a first user. The method may include displaying, on the first user device, at least a portion of the plurality of images. The plurality of images may be associated with one or more random categories. The method may include receiving, from the first user device, a first user input for at least the portion of the plurality of images. The first user input may include one or more first preference indications for at least the portion of the plurality of images. The method may include comparing, for at least the portion of the plurality of images, the one or more first preference indications to one or more second preference indications. The one or more second preference indications received from a second user device may be associated with a second user. The method may include determining an overlap between the one or more first preference indications and the one or more second preference indications based at least in part on the comparing. The method may include, in response to determining the overlap between the one or more first preference indications and the one or more second preference indications exceeds a threshold, automatically causing a graphical user interface associated with the first or the second user device to indicate a match between the first and the second user.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for profile matching, in accordance with one or more implementations.

FIGS. 2A, 2B, 2C, 2D, 2E, 2F, 2G, 2H, and/or 2I illustrate a method for profile matching, in accordance with one or more implementations.

FIG. 3A illustrates a process flow for profile matching, in accordance with one or more implementations.

FIG. 3B illustrates a process flow for profile matching, in accordance with one or more implementations.

FIG. 4 illustrates a visualization of a profile matching application on a user device according to an embodiment of the disclosure.

FIG. 5 illustrates a profile matching system according to an embodiment of the disclosure.

FIG. 6 illustrates a visualization of the profile matching application in FIG. 4 following a match between two users, in accordance with one or more implementations.

FIG. 7 is a block diagram illustrating a computer system according to various embodiments of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

As detailed above, the disclosure generally relates to a system and a method for profile matching based on analyzing user preference indications for images from one or more sets of images associated with different categories. In some embodiments, the profile matching system may utilize a matching algorithm that receives as input a user's preference indications for images from multiple sets and provides as output one or more matching values for the user with respect to other users that have also selected or tapped on images based on their individual preferences. In some cases, the profile matching system of the current disclosure alleviates some of the deficiencies of existing dating platforms by not only filtering out fake profiles or scammers, for instance, by only displaying profiles that are actively participating in the tapping process, but also by removing any notion of right or wrong answers. In this way, users are incentivized to provide honest answers of their preferences (e.g., skiing image vs mountain biking image), rather than answer in a way that favors what they think people want to hear.

In some embodiments, the results are matches that are based on authentic selections of what users love. Further, as the user goes through the process and taps on more and more images based on their preferences, the matches become accurate. In some cases, the match value between a user and previously matched users may also be updated based on the user tapping or selecting more and more images. In this way, some previously matched users may be moved higher up in the compatibility list, while others may be removed due to their lack of compatibility with the user, unless there is active communication with the user. In some aspects, this results in users matching with people who enjoy or see the world in a similar way, which not only enhances forming romantic relationships, but also platonic relationships or friendships. Broadly, the matching algorithm allows matches to be generated by users liking a lot of the same things, or by users liking a few of the same things but to a greater degree. In some embodiments, the profile matching system may allow users to select a search radius (e.g., 5 miles, 25 miles, etc.) such that they are only matched with other users within that radius. Further, the profile matching system may allow users to select a home location, and add a temporary location (e.g., while traveling). In some cases, a user may select a different radius for the temporary location, for instance, due to the lack of personal transport to meet up with someone outside a 1 or 2 mile radius. In such cases, the profile matching system may display matches from both the home location and the temporary location while a user is in travel mode.

In some cases, the selection or tapping process involving a user tapping one of several images may also provide a seamless way to run ads. In some examples, the ads may relate to one or more products from a company and may provide exposure to the company. Furthermore, the user selection may provide data on the preference(s) of different demographic(s) within a geographic region for the advertising company. Additionally or alternatively, the data may also be compiled by the dating platform of the current disclosure, for instance, using analytics, where the analytics may be used to generate predictions on other products or services that users may be interested in so that future ads from other companies may be shown to the users most likely to be interested in their products.

In some other cases, categories (e.g., mountain biking) may be rented or bid upon by a company. In such cases, instead of displaying stock images of mountain bikes, mountain bikes from a particular mountain bike manufacturer may be displayed to users going through the tapping process, such that users may only be exposed to that mountain bike manufacturer for the associated activity or interest.

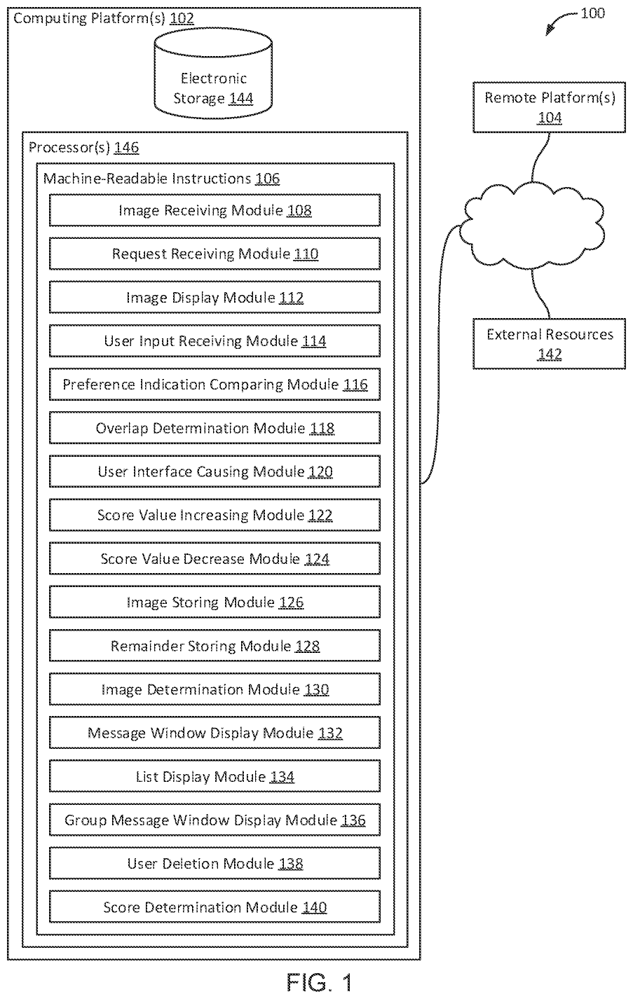

FIG. 1 illustrates a system 100 configured for profile matching, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of image receiving module 108, request receiving module 110, image display module 112, user input receiving module 114, preference indication comparing module 116, overlap determination module 118, user interface causing module 120, score value increasing module 122, score value decrease module 124, image storing module 126, remainder storing module 128, image determination module 130, message window display module 132, list display module 134, group message window display module 136, user deletion module 138, score determination module 140, and/or other instruction modules.

Image receiving module 108 may be configured to electronically receive, atone or more computer systems, a plurality of images from one or more sources. Prior to displaying at least the portion of the plurality of images, the image receiving module may be configured to determine if at least one image in the prioritized image list has been selected more than a threshold number of times (e.g., 10 times). If so, the at least one image in the prioritized image list no longer appears for selection based in part on the determining, further described below. Additionally or alternatively, prior to displaying at least the portion of the plurality of images, the image receiving module may be configured to determine if at least one image in the non-prioritized image list has been unselected more than a threshold number of times (e.g., 10 times). If so, the at least one image in the non-prioritized image list no longer appears for selection based in part on the determining, also further described below.

Request receiving module 110 may be configured to electronically receive, via a first user device, a first request for profile matching from a first user.

Image display module 112 may be configured to display, on the first user device, at least a portion of the plurality of images. The plurality of images may be associated with one or more random categories (e.g., outdoor activity, cars, food, fashion, travel destinations, movies, music, etc.). The two or more images may be associated with a random category of the one or more random categories. For instance, in one example, the category may be music, and a first image may be a poster of a Rock/Heavy Metal band, while the second image may be a poster of a Rap/Hip-Hop artist. In another example, the category may be travel destinations, and a first image may be a skyline of Paris showing the Eiffel Tower, while the second image may be a remote national park in Alaska.

User input receiving module 114 may be configured to receive, from the first user device, a first user input for at least the portion of the plurality of images. The first user input may include one or more first preference indications for at least the portion of the plurality of images. The match value may be based on determining respective total scores for each image of the at least the portion of the plurality of images.

Preference indication comparing module 116 may be configured to compare, for at least the portion of the plurality of images, the one or more first preference indications to one or more second preference indications. The one or more second preference indications received from a second user device may be associated with a second user.

Preference indication comparing module 116 may be configured to, in response to determining the overlap between the one or more first preference indications and the one or more second preference indications does not exceed the threshold, compare the one or more first preference indications to one or more third preference indications. The one or more third preference indications received from a third user device may be associated with a third user.

Overlap determination module 118 may be configured to determine an overlap between the one or more first preference indications and the one or more second preference indications based at least in part on the comparing.

Overlap determination module 118 may be configured to determine an overlap between the one or more first preference indications and the one or more third preference indications based at least in part on the comparing. By way of non-limiting example, determining the overlap between the first preference indications and the one or more second preference indications may further include computing, using a matching algorithm, a match value for the first and second users.

User interface causing module 120 may be configured to, in response to determining the overlap between the one or more first preference indications and the one or more second preference indications exceeds a threshold, automatically cause a graphical user interface associated with the first or the second user device to indicate a match between the first and the second user.

User interface causing module 120 may be configured to, in response to determining the overlap between the one or more first preference indications and the one or more third preference indications exceeds the threshold, automatically cause a graphical user interface associated with the first or the third user device to indicate a match between the first and the third user.

Score value increasing module 122 may be configured to increase a respective score value associated with the first and second images based in part on the selecting the first and second images respectively.

Score value decrease module 124 may be configured to decrease a respective score value for at least one of the unselected images in the first and second sets of images.

Image storing module 126 may be configured to store the first image and the second image in a prioritized image list based at least in part on the associating the selection of the first and second images respectively.

Remainder storing module 128 may be configured to store a remainder of images from the first and the second set of images in a non-prioritized image list.

Image determination module 130 may be configured to determine if at least one image in the prioritized image list has been selected more than a threshold number of times.

Image determination module 130 may be configured to determine if at least one image in the non-prioritized image list has been unselected more than a threshold number of times. In some embodiments, the at least one image in the prioritized image list may no longer appear for selection based in part on the determining. Additionally or alternatively, the at least one image in the non-preferred image list may no longer appear for selection based in part on the determining.

Message window display module 132 may be configured to display, on a respective graphical user interface of the first or the second user device, a private message window for allowing one of the first or the second user to initiate contact with the other user via a direct message based at least in part on indicating the match between the first and the second user.

List display module 134 may be configured to display, on the graphical user interface of the first user device, a list of matched users associated with the first user including at least the second user and a third user.

List display module 134 may be configured to display, on the graphical user interface of the first user device, a list of matched users associated with the first user.

Group message window display module 136 may be configured to display, on the graphical user interface of the first user device, a group message window for allowing the first user to initiate a group conversation with at least the second user and the third user.

User deletion module 138 may be configured to automatically delete at least one matched user from the list of matched users based on determining an absence of communication between the at least one matched user and the first user, determining that a respective match value associated with the at least one matched user and the first user is under a match threshold value, or a combination thereof.

Score determination module 140 may be configured to determine, for the first user, a total score for each image of the at least the portion of the plurality of images based in part on the first preference indications.

Score determination module 140 may be configured to determine, for the second user, a total score for each image of the at least the portion of the plurality of images based in part on the second preference indications.

In some implementations, the displaying may include displaying one or more sets of images, at least one of the sets of images including two or more images. In some implementations, by way of non-limiting example, displaying a respective set of images may be based at least in part on identifying that a first image from the respective set of images has not previously appeared against, been prioritized over, or a combination thereof, a second image from the respective set of images. In some implementations, the receiving the first user input may include selecting, by the first user, a first image from a first set of images. In some implementations, the receiving the first user input may include associating the selection of the first image with a first one of the first preference indications. In some implementations, the receiving the first user input may include selecting, by the first user, a second image from a second set of images.

In some implementations, the receiving the first user input may include associating the selection of the second image with a second one of the first preference indications.

In some implementations, server(s) 102, client computing platform(s) 104, and/or external resources 142 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 142 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 142, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 142 may include sources of information outside of system 100, external entities participating with system 100, and/or other resources. In some implementations, some or all of the functionality attributed herein to external resources 142 may be provided by resources included in system 100.

Server(s) 102 may include electronic storage 144, one or more processors 146, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 144 may comprise non-transitory storage media that electronically stores information. The electronic storage media of electronic storage 144 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 144 may include one or more of optically readable storage media (e.g., optical disks, etc.), magnetically readable storage media (e.g., magnetic tape, magnetic hard drive, floppy drive, etc.), electrical charge-based storage media (e.g., EE PROM, RAM, etc.), solid-state storage media (e.g., flash drive, etc.), and/or other electronically readable storage media. Electronic storage 144 may include one or more virtual storage resources (e.g., cloud storage, a virtual private network, and/or other virtual storage resources). Electronic storage 144 may store software algorithms, information determined by processor(s) 146, information received from server(s) 102, information received from client computing platform(s) 104, and/or other information that enables server(s) 102 to function as described herein.

Processor(s) 146 may be configured to provide information processing capabilities in server(s) 102. As such, processor(s) 146 may include one or more of a digital processor, an analog processor, a digital circuit designed to process information, an analog circuit designed to process information, a state machine, and/or other mechanisms for electronically processing information. Although processor(s) 146 is shown in FIG. 1 as a single entity, this is for illustrative purposes only. In some implementations, processor(s) 146 may include a plurality of processing units. These processing units may be physically located within the same device, or processor(s) 146 may represent processing functionality of a plurality of devices operating in coordination. Processor(s) 146 may be configured to execute modules 108, 110, 112, 114, 116, 118, 120, 122, 124, 126, 128, 130, 132, 134, 136, 138, and/or 140, and/or other modules. Processor(s) 146 may be configured to execute modules 108, 110, 112, 114, 116, 118, 120, 122, 124, 126, 128, 130, 132, 134, 136, 138, and/or 140, and/or other modules by software; hardware; firmware; some combination of software, hardware, and/or firmware; and/or other mechanisms for configuring processing capabilities on processor(s) 146. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, and/or 140 are illustrated in FIG. 1 as being implemented within a single processing unit, in implementations in which processor(s) 146 includes multiple processing units, one or more of modules 108, 110, 112, 114, 116, 118, 120, 122, 124, 126, 128, 130, 132, 134, 136, 138, and/or 140 may be implemented remotely from the other modules. The description of the functionality provided by the different modules 108, 110, 112, 114, 116, 118, 120, 122, 124, 126, 128, 130, 132, 134, 136, 138, and/or 140 described below is for illustrative purposes, and is not intended to be limiting, as any of modules 108, 110, 112, 114, 116, 118, 120, 122, 124, 126, 128, 130, 132, 134, 136, 138, and/or 140 may provide more or less functionality than is described. For example, one or more of modules 108, 110, 112, 114, 116, 118, 120, 122, 124, 126, 128, 130, 132, 134, 136, 138, and/or 140 may be eliminated, and some or all of its functionality may be provided by other ones of modules 108, 110, 112, 114, 116, 118, 120, 122, 124, 126, 128, 130, 132, 134, 136, 138, and/or 140. As another example, processor(s) 146 may be configured to execute one or more additional modules that may perform some or all of the functionality attributed below to one of modules 108, 110, 112, 114, 116, 118, 120, 122, 124, 126, 128, 130, 132, 134, 136, 138, and/or 140.

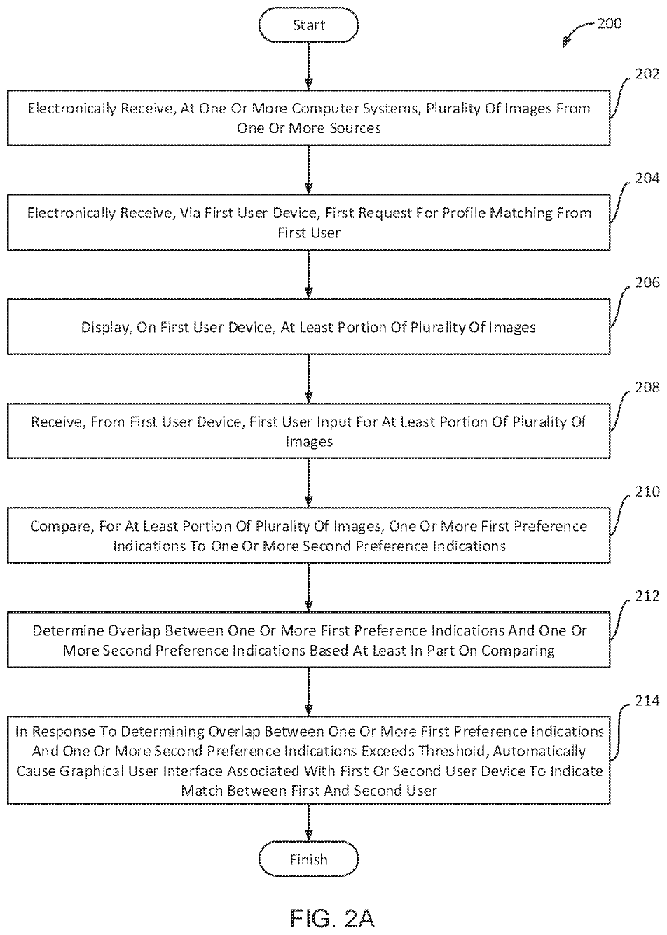

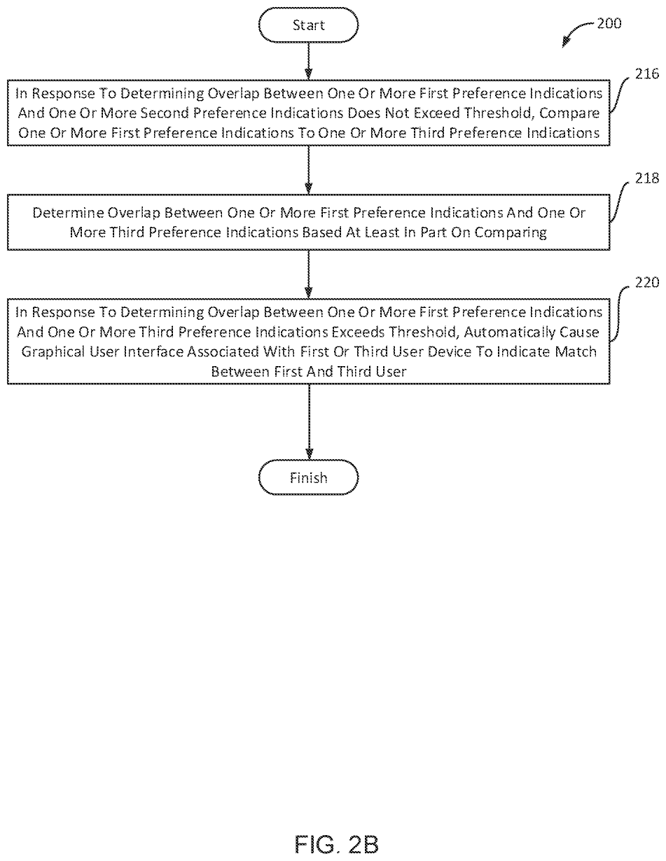

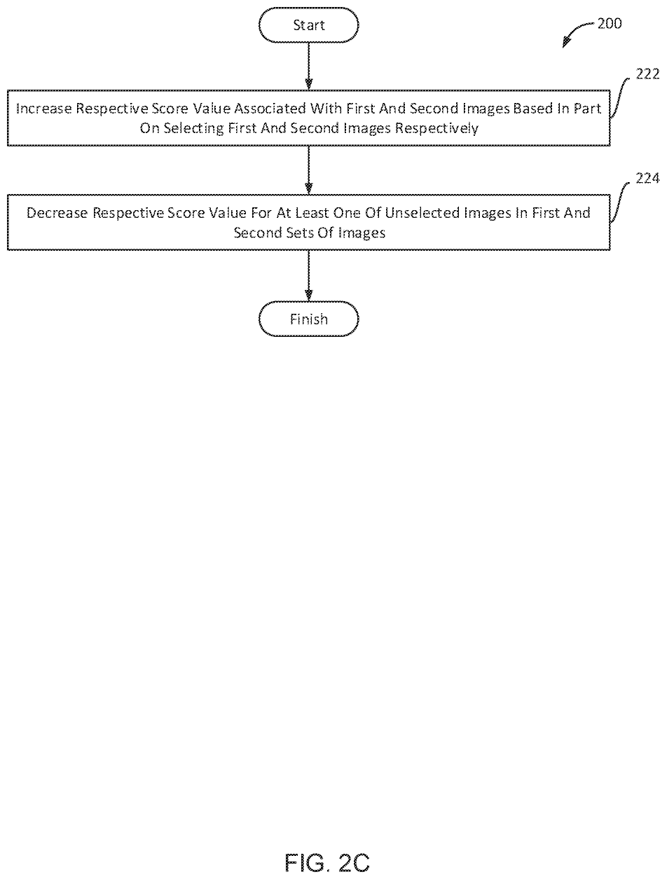

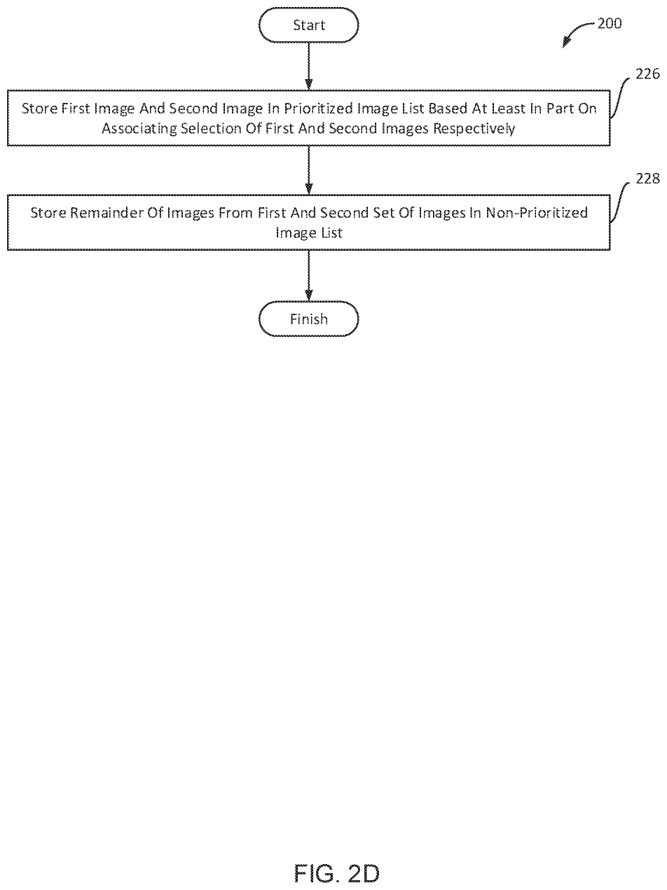

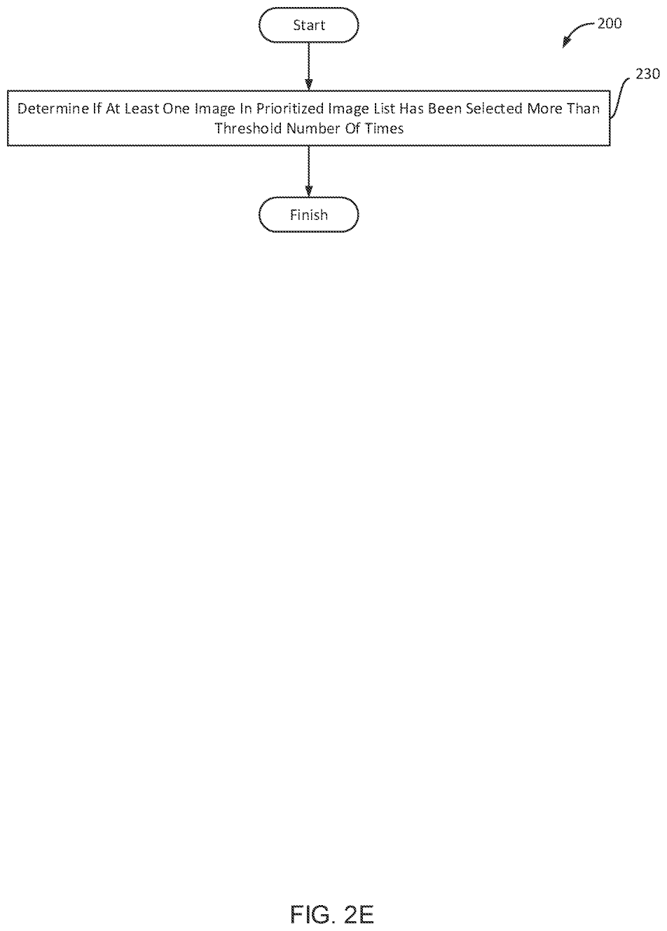

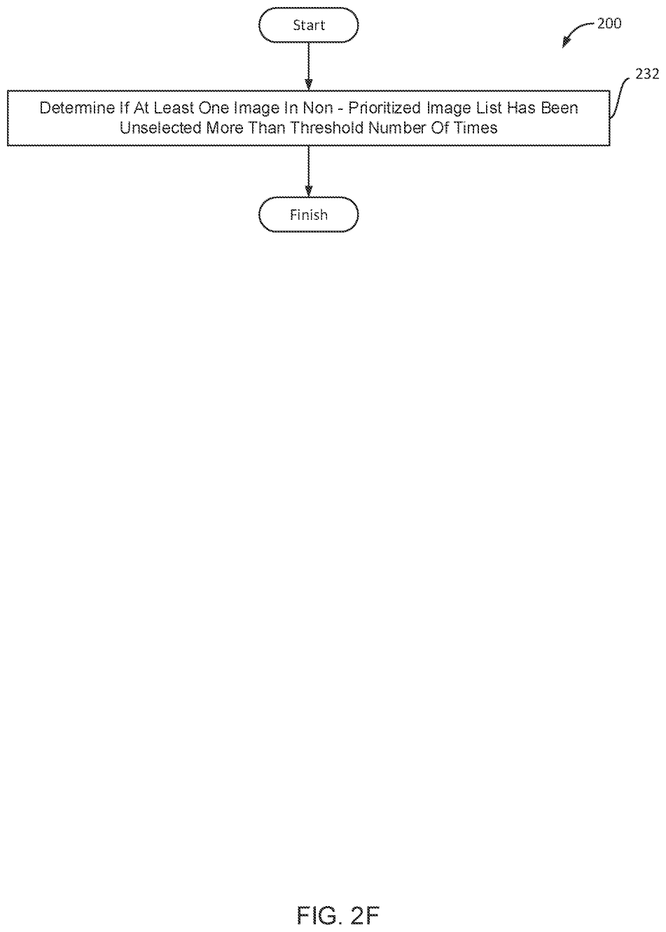

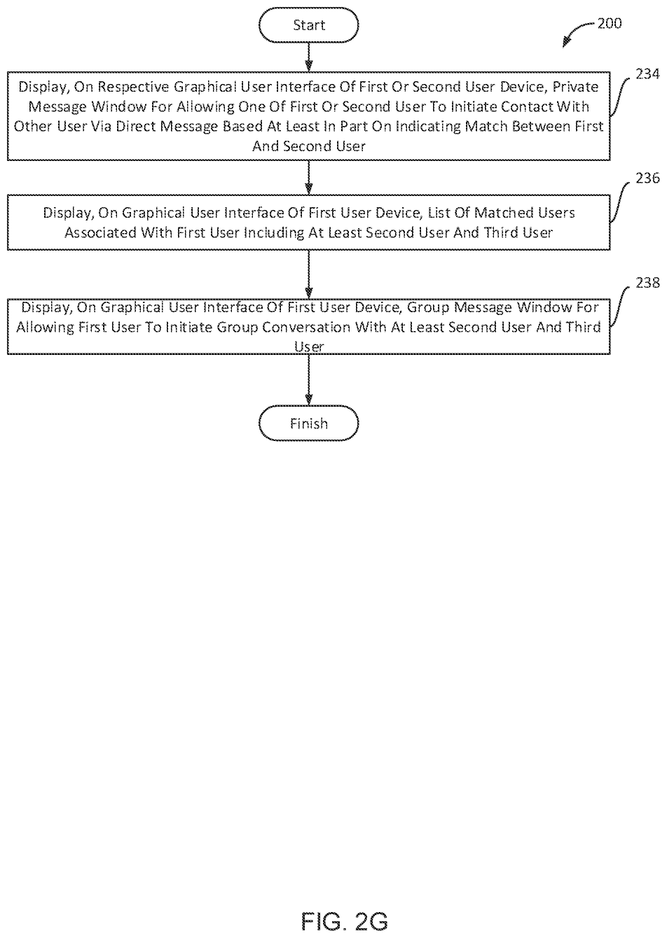

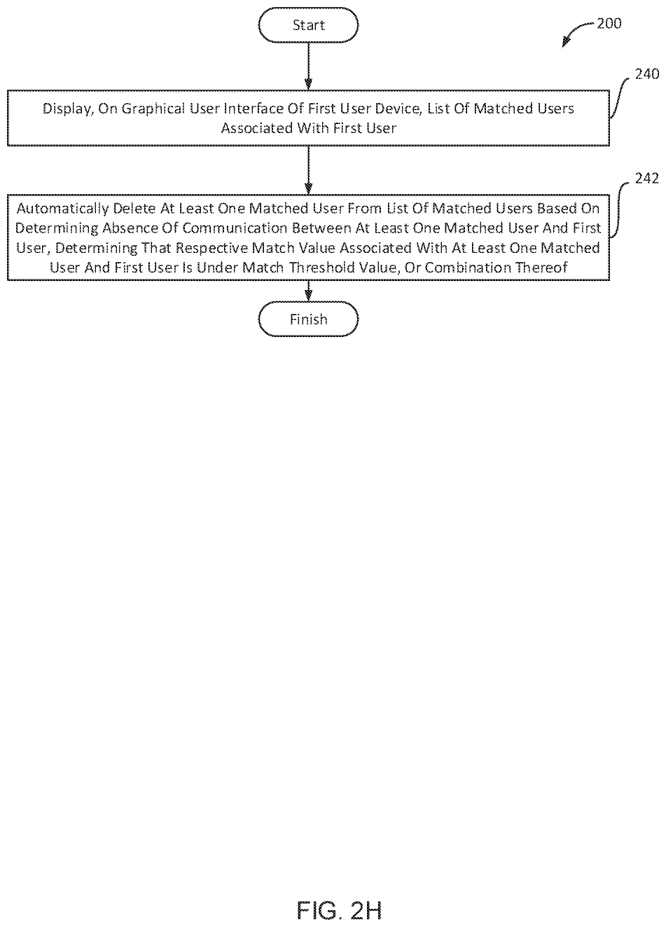

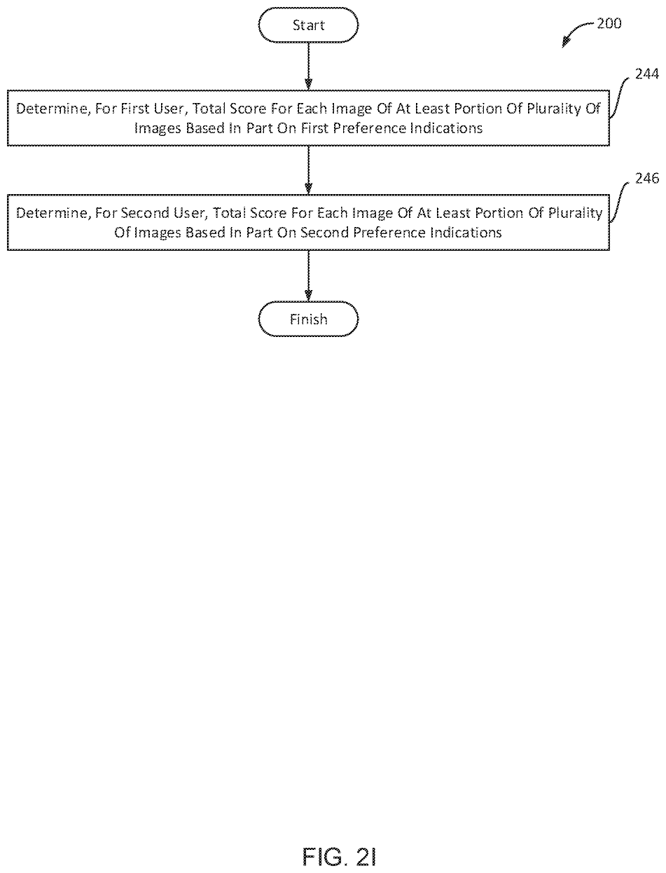

FIGS. 2A, 2B, 2C, 2D, 2E, 2F, 2G, 2H, and/or 2I illustrate a method 200 for profile matching, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A, 2B, 2C, 2D, 2E, 2F, 2G, 2H, and/or 2I and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200, in accordance with one or more implementations.

An operation 202 may include electronically receiving, at one or more computer systems, a plurality of images from one or more sources. Operation 202 may be performed by one or more hardware processors configured by machine-readable instructions including a module that is the same as or similar to image receiving module 108, in accordance with one or more implementations.

An operation 204 may include electronically receiving, via a first user device, a first request for profile matching from a first user. Operation 204 may be performed by one or more hardware processors configured by machine-readable instructions including a module that is the same as or similar to request receiving module 110, in accordance with one or more implementations.

An operation 206 may include displaying, on the first user device, at least a portion of the plurality of images. The plurality of images may be associated with one or more random categories. Operation 206 may be performed by one or more hardware processors configured by machine-readable instructions including a module that is the same as or similar to Image display module 112, in accordance with one or more implementations.

An operation 208 may include receiving, from the first user device, a first user input for at least the portion of the plurality of images. The first user input may include one or more first preference indications for at least the portion of the plurality of images. Operation 208 may be performed by one or more hardware processors configured by machine-readable instructions including a module that is the same as or similar to user input receiving module 114, in accordance with one or more implementations.

An operation 210 may include comparing, for at least the portion of the plurality of images, the one or more first preference indications to one or more second preference indications. The one or more second preference indications received from a second user device may be associated with a second user. Operation 210 may be performed by one or more hardware processors configured by machine-readable instructions including a module that is the same as or similar to preference indication comparing module 116, in accordance with one or more implementations.

An operation 212 may include determining an overlap between the one or more first preference indications and the one or more second preference indications based at least in part on the comparing. Operation 212 may be performed by one or more hardware processors configured by machine-readable instructions including a module that is the same as or similar to overlap determination module 118, in accordance with one or more implementations.

An operation 214 may include in response to determining the overlap between the one or more first preference indications and the one or more second preference indications exceeds a threshold, automatically causing a graphical user interface associated with the first or the second user device to indicate a match between the first and the second user. Operation 214 may be performed by one or more hardware processors configured by machine-readable instructions including a module that is the same as or similar to user interface causing module 120, in accordance with one or more implementations.

FIG. 2B illustrates method 200, in accordance with one or more implementations.

An operation 216 may include in response to determining the overlap between the one or more first preference indications and the one or more second preference indications does not exceed the threshold, comparing the one or more first preference indications to one or more third preference indications. The one or more third preference indications received from a third user device may be associated with a third user. Operation 216 may be performed by one or more hardware processors configured by machine-readable instructions including a module that is the same as or similar to preference indication comparing module 116, in accordance with one or more implementations.

An operation 218 may include determining an overlap between the one or more first preference indications and the one or more third preference indications based at least in part on the comparing. Operation 218 may be performed by one or more hardware processors configured by machine-readable instructions including a module that is the same as or similar to overlap determination module 118, in accordance with one or more implementations.

An operation 220 may include in response to determining the overlap between the one or more first preference indications and the one or more third preference indications exceeds the threshold, automatically causing a graphical user interface associated with the first or the third user device to indicate a match between the first and the third user. Operation 220 may be performed by one or more hardware processors configured by machine-readable instructions including a module that is the same as or similar to user interface causing module 120, in accordance with one or more implementations.

FIG. 2C illustrates method 200, in accordance with one or more implementations.

An operation 222 may include increasing a respective score value associated with the first and second images based in part on the selecting the first and second images respectively. Operation 222 may be performed by one or more hardware processors configured by machine-readable instructions including a module that is the same as or similar to score value increasing module 122, in accordance with one or more implementations.

An operation 224 may include decreasing a respective score value for at least one of the unselected images in the first and second sets of images. Operation 224 may be performed by one or more hardware processors configured by machine-readable instructions including a module that is the same as or similar to score value decrease module 124, in accordance with one or more implementations.

FIG. 2D illustrates method 200, in accordance with one or more implementations.

An operation 226 may include storing the first image and the second image in a prioritized image list based at least in part on the associating the selection of the first and second images respectively. Operation 226 may be performed by one or more hardware processors configured by machine-readable instructions including a module that is the same as or similar to image storing module 126, in accordance with one or more implementations.

An operation 228 may include storing a remainder of images from the first and the second set of images in a non-prioritized image list. Operation 228 may be performed by one or more hardware processors configured by machine-readable instructions including a module that is the same as or similar to remainder storing module 128, in accordance with one or more implementations.

FIG. 2E illustrates method 200, in accordance with one or more implementations.

An operation 230 may include determining if at least one image in the prioritized image list has been selected more than a threshold number of times. Operation 230 may be performed by one or more hardware processors configured by machine-readable instructions including a module that is the same as or similar to image determination module 130, in accordance with one or more implementations.

FIG. 2F illustrates method 200, in accordance with one or more implementations.

An operation 232 may include determining if at least one image in the non-prioritized image list has been unselected more than a threshold number of times. Operation 232 may be performed by one or more hardware processors configured by machine-readable instructions including a module that is the same as or similar to image determination module 130, in accordance with one or more implementations.

FIG. 2G illustrates method 200, in accordance with one or more implementations.

An operation 234 may include displaying, on a respective graphical user interface of the first or the second user device, a private message window for allowing one of the first or the second user to initiate contact with the other user via a direct message based at least in part on indicating the match between the first and the second user. Operation 234 may be performed by one or more hardware processors configured by machine-readable instructions including a module that is the same as or similar to message window display module 132, in accordance with one or more implementations.

An operation 236 may include displaying, on the graphical user interface of the first user device, a list of matched users associated with the first user including at least the second user and a third user. Operation 236 may be performed by one or more hardware processors configured by machine-readable instructions including a module that is the same as or similar to list display module 134, in accordance with one or more implementations.

An operation 238 may include displaying, on the graphical user interface of the first user device, a group message window for allowing the first user to initiate a group conversation with at least the second user and the third user. Operation 238 may be performed by one or more hardware processors configured by machine-readable instructions including a module that is the same as or similar to group message window display module 136, in accordance with one or more implementations.

FIG. 2H illustrates method 200, in accordance with one or more implementations.

An operation 240 may include displaying, on the graphical user interface of the first user device, a list of matched users associated with the first user. Operation 240 may be performed by one or more hardware processors configured by machine-readable instructions including a module that is the same as or similar to list display module 134, in accordance with one or more implementations.

An operation 242 may include automatically deleting at least one matched user from the list of matched users based on determining an absence of communication between the at least one matched user and the first user, determining that a respective match value associated with the at least one matched user and the first user is under a match threshold value, or a combination thereof. Operation 242 may be performed by one or more hardware processors configured by machine-readable instructions including a module that is the same as or similar to user deletion module 138, in accordance with one or more implementations.

FIG. 2I illustrates method 200, in accordance with one or more implementations.

An operation 244 may include determining, for the first user, a total score for each image of the at least the portion of the plurality of images based in part on the first preference indications. Operation 244 may be performed by one or more hardware processors configured by machine-readable instructions including a module that is the same as or similar to score determination module 140, in accordance with one or more implementations.

An operation 246 may include determining, for the second user, a total score for each image of the at least the portion of the plurality of images based in part on the second preference indications. Operation 246 may be performed by one or more hardware processors configured by machine-readable instructions including a module that is the same as or similar to score determination module 140, in accordance with one or more implementations.

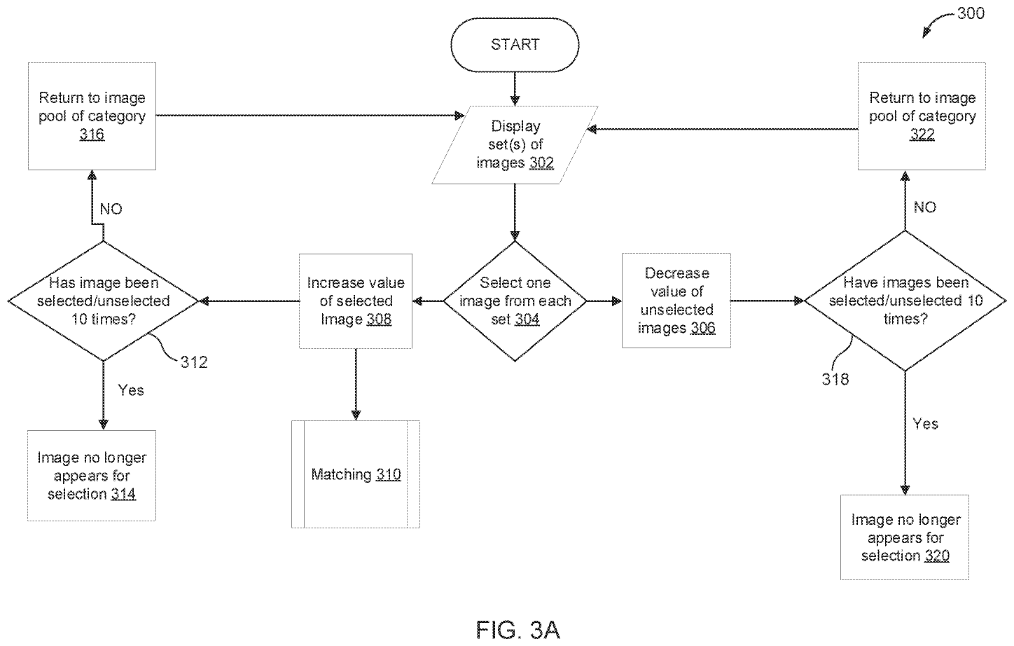

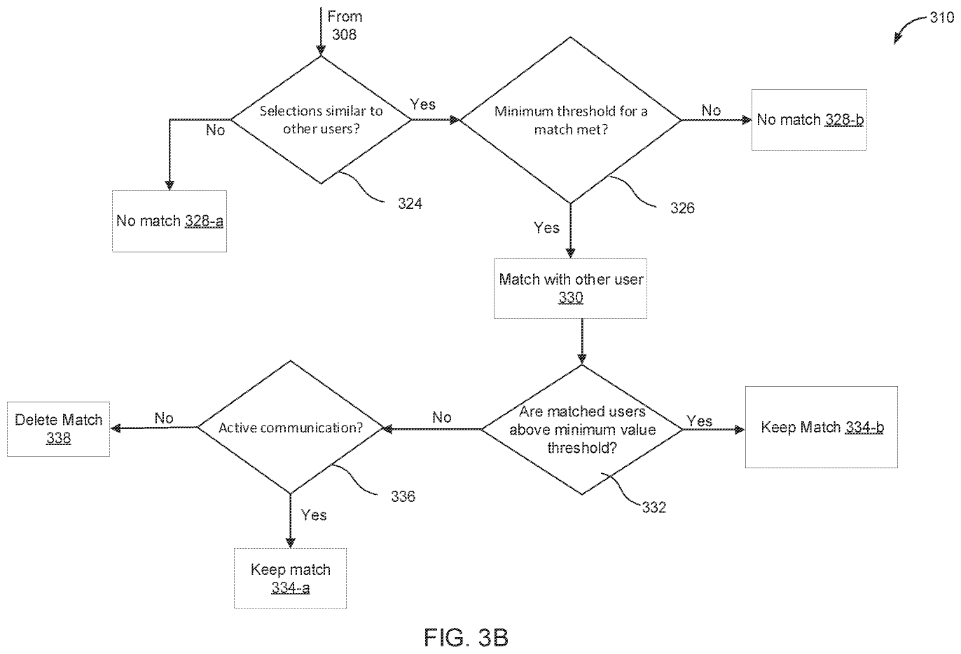

FIG. 3A illustrates a process flow 300 for profile matching, in accordance with one or more implementations. In some cases, process flow 300 may implement one or more aspects of the figures described herein.

In some cases, a profile matching system, such as system 100 described in relation to FIG. 1, may electronically receive a plurality of images from one or more sources (e.g., a website, social media, stock image source, etc.). At 302, the profile matching system may be configured to display one or more sets of images on a user device associated with a first user. In some examples, each set of images may be associated with a category, an interest, or an activity, to name a few non-limiting examples. In some cases, each set of images may comprise two or more images. For instance, a first set of images may include an image associated with a Rock band, and another image associated with a Pop act (e.g., Michael Jackson), and yet another image associated with a Rap/Hip-Hop act (e.g., Eminem). In this case, the category of the first set of images is Music. In another example, a second set of images may be associated with Food, which may include images of a Pizza, Salad, and Sushi.

At 304, the first user may be prompted to select or tap on an image from each set of images based on their preference. In some cases, the user input may comprise a tapping or clicking gesture on a touch screen interface of the user device. Alternatively, the user input may comprise a user typing in a number (e.g., 1 for the first image, 2 for the second image) or a letter (e.g., ‘A’ for the first image, ‘B’ for the second image), to name two non-limiting examples. After receiving the user input via the user device, the profile matching system may increase a value associated with the selected image at 308, and decrease a value associated with the one or more unselected images at 306. Following updating and storing the values associated with each image of the first set, the profile matching system may display two or more images of a next set of images on the visual display of the user device.

At 310, the profile matching system may proceed to match the user with one or more other users based on analyzing their preference indications for images, further described in relation to FIG. 3B. In some cases, the one or more users may be shown the same or similar sets of images associated with one or more categories. For instance, the sets of images shown to different users may comprise at least one common image per set. Similar to the input received from the first user, the one or more users may be prompted to select or tap on an image from a set of images based on their preference. In this way, the result or output from the profile matching system may comprise an indication of one or more matches, where the one or more matches are based in part on authentic selections of what users love. Further, the matching algorithm of the profile matching system may utilize artificial intelligence or machine learning techniques that may serve to enhance the matching accuracy as a user goes through the process and taps or selects more and more images.

Following increasing the value of the selected image at 308, and prior to displaying the next set of images, the profile matching system may check if the selected image has been selected or unselected a threshold number of times (e.g., 10 times) by the first user, at 312. If yes, the image may no longer appear for selection and may be placed in a do-not-display list at 314. If no, the image may be returned to an image pool associated with the particular category at 316. In some embodiments, prior to displaying a set of images, the profile matching system may be configured to check if an image scheduled to be displayed in the set has already appeared against another image also scheduled to be displayed in the set. In some cases, an image that has already appeared against another image and/or been preferred over the other image may not appear against the other image.

Additionally or alternatively, following decreasing a respective value of each unselected image at 306, and prior to displaying the next set of images, the profile matching system may check if the unselected image(s) have been selected or unselected a threshold number of times (e.g., 10 times) by the first user, at 318. If yes, the image may no longer appear for selection and may be placed in the do-not-display list at 320. If no, the unselected image(s) may be returned to an image pools associated with the particular category at 322. In some cases, each category may comprise an associated image pool, and the profile matching system may randomly cycle through different images from the image pool associated with a category, or randomly cycle through different image pools associated with different categories.

FIG. 3B continues the process flow previously described in relation to FIG. 3A and focuses on the matching 310 sub-process. As seen, after increasing the value of the selected image at 308, the process flow 310 may comprise checking if the selections or preference indications from the first user are similar to other users at 324. If no, the profile matching system may determine no match between the first user and the at least one other user (e.g., a second user) at 328-a. If yes, at 326, the profile matching system may check if a minimum threshold for a match is met (i.e., with at least one other user). If yes, the profile matching system may indicate a match with the at least one other user at 330. Contrastingly, if the minimum threshold for a match is not met, the profile matching system may determine no match between the user and the at least one other user at 328-b. In some cases, the profile matching system may or may not display an indication of no match with another user.

Returning to 330, after the profile matching system determines a match between the first user and another user, the profile matching system may alert the first user and/or the other user of the match. For instance, the profile matching system may display a pop-up window, a push notification, a text message, an email, to name a few non-limiting examples on the user device(s) of the first and/or the second user. In some cases, once a first and second user have been matched, the profile matching system may allow the matched users to initiate a conversation with the other user. In some cases, a message window may be displayed on the respective user devices, which may allow transfer of text, voice, and/or video messages between the matched users.

As shown, at 332, the profile matching system may check if the matched users are above a minimum value threshold. It should be noted that the minimum value threshold at 332 may be different from the minimum threshold for a match previously checked at 326. In some cases, if the matched users are above the minimum value threshold, the profile matching system may keep the match at 334-b. In some other cases, if matched users are below the minimum value threshold, the profile matching system may determine if there has been active communication between the matched users. If no, the profile matching system may delete the match between the first user and another user at 338. However, if the profile matching system determines active communication between the first user and the other user, the system may keep the match at 334-a, even if the minimum value threshold is not met. Additionally or alternatively, the profile matching system may prompt at least one of the two matched users for input on keeping or deleting the match with the other user. In some cases, the minimum value threshold at 332 may be the same as the minimum threshold for the match previously checked at 326. However, as the user taps through more and more images, an associated match value between the user and a previously matched user may be updated. In such cases, if the updated match value is under the minimum threshold for a match, the previously matched user may be removed from the user's match list.

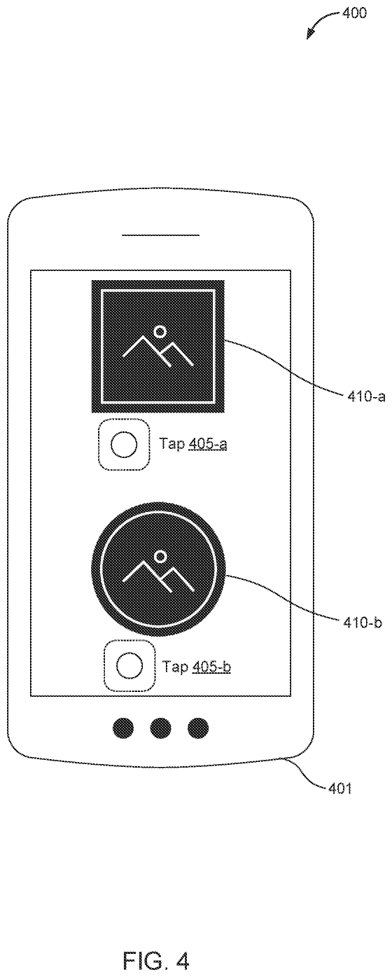

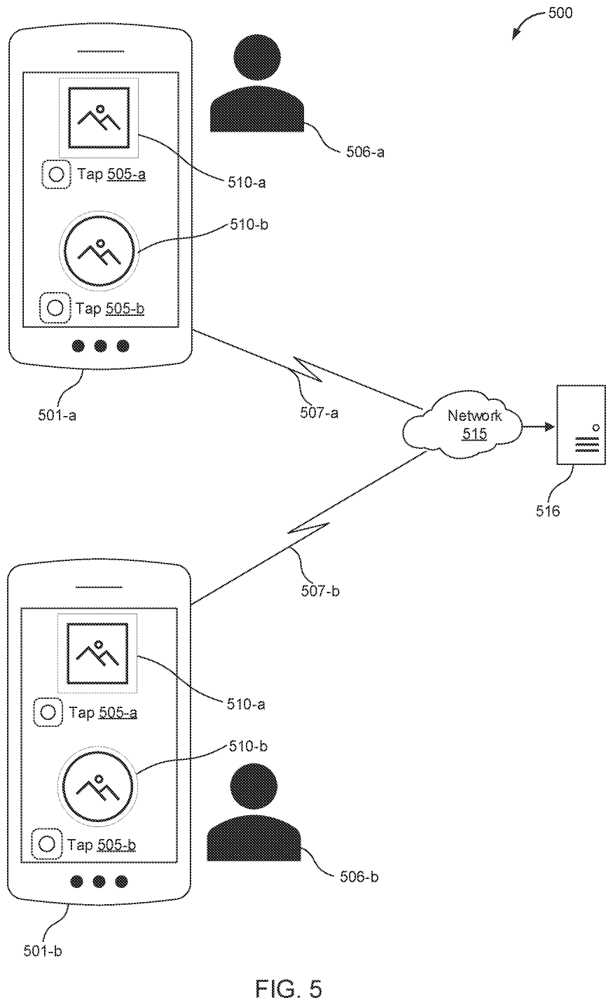

FIG. 4 illustrates a visualization of a profile matching system 400 in accordance with one or more implementations. As seen, the profile matching system 400 may facilitate an on-line dating scenario in a network environment and may comprise a user device 401 associated with a first user (not shown). In some cases, users, such as the first user, may interact with a matching server (shown as matching server 516 in FIG. 5) through the user device 401. In some embodiments, the user device 401 may comprise a visual display, input devices (e.g., keyboard, mouse, touchscreen interface, microphone, camera, etc.) for receiving user input, a processing unit, microprocessors, memory, etc. Furthermore, the user device 401 may be configured to communicate through wired or wireless means (e.g., Wi-Fi, cellular, such as 4G or 5G, WiMax, Bluetooth, etc.) with one or more other user devices, the matching server, etc.

As illustrated, the user device 401 may be configured to display one or more sets of images, each set comprising at least two images (e.g., image 410-a and image 410-b). In some embodiments, a set of images may be associated with one category (e.g., outdoor activities, or traveling), and each category may comprise a plurality (or pool) of images. In some aspects, the profile matching system 400 may be configured to randomly select a category (e.g., outdoor activities) and then randomly select two or more images from within that category for display on the user device 401. As described in relation to FIG. 3A, the profile matching system may be configured to refrain from displaying, as a set, images that have previously appeared against each other. In some other cases, the profile matching system may also refrain from displaying, to a user, an image that has been selected or unselected a threshold number of times (e.g., 10 times, 20 times, etc.).

As shown, the user device 401 may be used to display a first image 410-a and a second image 410-b, where the first and second images are associated with a same category (e.g., traveling). In this example, the first image 410 may be of a tropical beach while the second image 410-b may be of an alpine region in winter. According to aspects of the present disclosure, the selection of the first image vs the second image is a reflexive decision and is largely subjective. The two images represent a preference in life within a given category, namely, if the user prefers to vacation on a warm, tropical beach and swim/snorkel/scuba dive or vacation in a cold alpine region and ski/snowboard. In some cases, the visual display on the user device 401 may display a tap icon 405 (e.g., tap icon 405-a, tap icon 405-b) adjacent or below each image 410. In this way, the user may select the image 410 that appeals most to them, which may then be used to match them with other likeminded users. In some cases, the tapping or selecting gesture for each set of images may be associated or linked to a preference indication for the user. In some embodiments, one or more preference indications from a user may be compared to other preference indications received from other users. Further, a match value between two users may be based in part on comparing the received preference indications and determining an overlap between the preference indications, further described in relation to FIG. 5.

FIG. 5 illustrates a profile matching system 500 according to an embodiment of the disclosure. The profile matching system 500 may be similar or substantially similar to the profile matching system 400 previously described in relation to FIG. 4. Further, profile matching system 500 may implement one or more aspects of the other figures described herein.

As shown, profile matching system 500 comprises a user device 501-a associated with a first user 506-a and another user device 501-b associated with a second user 506-b. Some non-limiting examples of user device(s) 501 may include a smartphone, a laptop, a PDA, a NetBook, or a tablet. The user device(s) 501 may comprise wired and/or wireless communication capabilities and may comprise a visual display, input/output devices, a processor, memory, etc. In some embodiments, the user device(s) 501 may be in communication with a matching server 516 over a network 515 via one or more communication links 507 (e.g., communication link 507-a, communication link 507-b).

As illustrated, the user devices 501 may be configured to display one or more sets of images, each set comprising at least two images (e.g., image 510-a and image 510-b). In some embodiments, a set of images may be associated with one category (e.g., outdoor activities, or traveling), and each category may comprise a plurality (or pool) of images. In some aspects, the profile matching system 500 may be configured to randomly select a category (e.g., outdoor activities) and then randomly select two or more images from within that category for display on the user devices 501. As described above, the profile matching system may be configured to refrain displaying, as a set, images that have previously appeared against each other. In some other cases, the profile matching system may also refrain from displaying, to a user, an image that has been selected or unselected a threshold number of times (e.g., 10 times). It should be noted that the image sets displayed on the different user devices may or may not be identical. Furthermore, one or more sets shown to the different users may comprise one or more common images.

In some cases, the visual display on the user devices 501 may display a tap icon 505 (e.g., tap icon 505-a, tap icon 505-b) adjacent or below each image 510. In this way, the user 506 may select the image 510 that appeals most to them, which may then be used to match them with other likeminded users. In some cases, the tapping or selecting gesture for each set of images may be associated or linked to a preference indication for the user 506. In some embodiments, one or more preference indications from a user, such as user 506-a, may be compared to other preference indications received from other users, such as user 506-b. In some examples, a match value between users 506-a and 506-b may be based in part on comparing the preference indications received from each user 506 and determining an overlap between the preference indications. In some embodiments, the match value may be determined at the matching server 516 and relayed back, via communication links 507, to the user devices 501 over network 515.

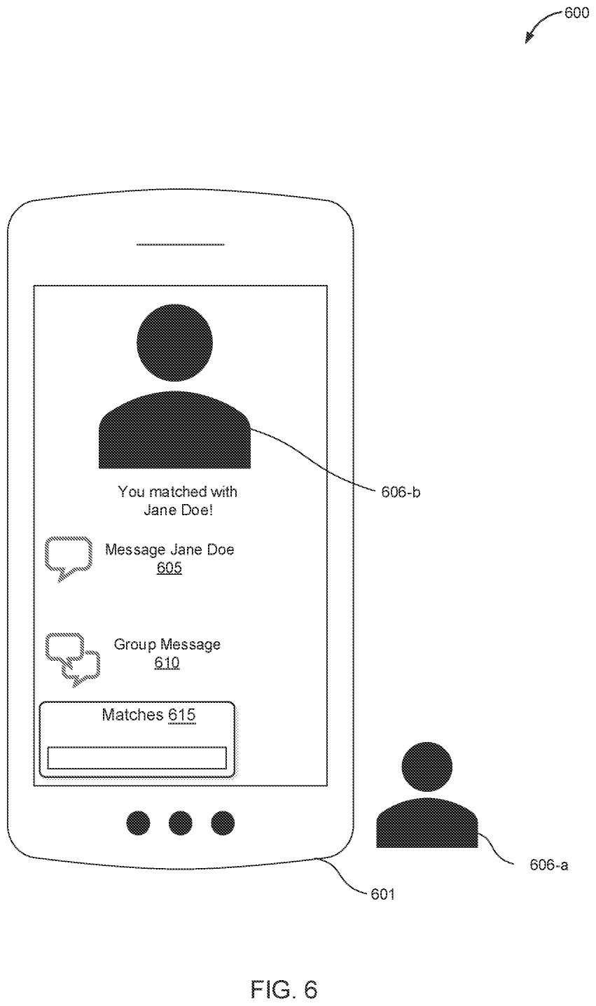

FIG. 6 illustrates a visualization of the profile matching application in FIGS. 4 and 5 following a match between two users, in accordance with one or more implementations. FIG. 6 implements one or more aspects of the figures described herein, including at least FIGS. 4 and 5. As seen, FIG. 6 depicts a profile matching system 600 comprising a user device 601 associated with a first user 606-a. The user device 601 comprises a visual display with or without touch-screen capabilities. In some cases, the profile matching system 600 may determine a match between the first user 606-a and a second user 606-b. In some embodiments, the profile matching system may display a profile picture of the second user 606-b on the visual display of the user device 601 following determining the match. As previously described, the match may be based on analyzing preference indications for various activities, interests, hobbies, etc., in life for the two users. In some embodiments, the first and second users 606 may be shown multiple sets of images, each comprising at least two images, where each set of images is associated with a random category. The first and second users may “tap” or select an image from each set of images based on what they love or what appeals to them. In this way, the results from the profile matching system are matches that are based on authentic selections of what users love. In some examples, match accuracy may be optimized as the users go through the process and tap through more and more images from different sets of images. In some aspects, this may facilitate in users matching with people who enjoy or see the world in a similar way, which may not only serve to form platonic relationships, but also romantic ones. In some embodiments, the profile matching system may utilize a matching algorithm, where the matching algorithm allows matches to be generated by users liking a lot of the same things, or by users liking a few of the same things but to a greater degree (i.e., an extreme amount).

As illustrated, in this example, the first user 606-a has matched with the second user 606-b based on the matching algorithm determining that the tapping or selections of images by the first user 606-a are similar or substantially similar to the second user 606-b. In some cases, the first user 606-a and second 606-b may match based on the matching algorithm or the profile matching system determining that a minimum threshold for a match has been met. In some embodiments, the profile matching system may continually check if the matched users are above a minimum value threshold, for instance, when one or more of the first and the second user tap on more images from new sets of images. In some embodiments, the profile matching system 600 may allow the first user 606-a to initiate a conversation with the second user 606-b via message icon 605. Upon clicking message icon 605, the visual display of the user device 601 may display a message window, where the first user 601 may type a personalized message to the second user 606-b via a user input device (e.g., keyboard) of the user device 601. In some cases, for instance, if the user device 601 has touchscreen capabilities, the user may type the message via an on-screen keyboard. Additionally or alternatively, the profile matching system 600 may also allow the first user 606-a to add additional matches from the matches 615 window and create a group conversation (see group message 610) with the second user 606-b and at least one other user. In some cases, the at least one other user may or may not need to be matched with both the first user and the second user 606-b in order to initiate a group conversation. In some other cases, the matches 615 window may be split into two sections—one showing all matches of user 606-a, the other showing common matches between the first user 606-a and the second user 606-b. In such cases, the first user 606-a may only initiate a group conversation with the common matches between the first and the second users 606. In some circumstances, the first user may use group conversations to start a discussion with other users on any topic, which may allow the first user to pique the attention of his/her matches. In some aspects, group conversations may be more interesting (at least to some users) and may offer a different way to communicate with matches.

Additionally or alternatively, the group conversations described above may facilitate in social meetups between one or more matches. In some examples, all users may be included as potential matches to all genders, although users may be able to toggle this feature (i.e., opt out). In some cases, the social meetup feature may allow a user to suggest a fun outing that may be even more fun with a mix of genders, personalities, etc. In some ways, this may alleviate the pressure of an awkward (or creepy) first date and may facilitate activities that users can bond over which may result in friendships. In some regards, the likelihood of users having interest in a match's proposed meetup may be quite high due to the tapping or selection process that matched them based on mutual interests in life in the first place.

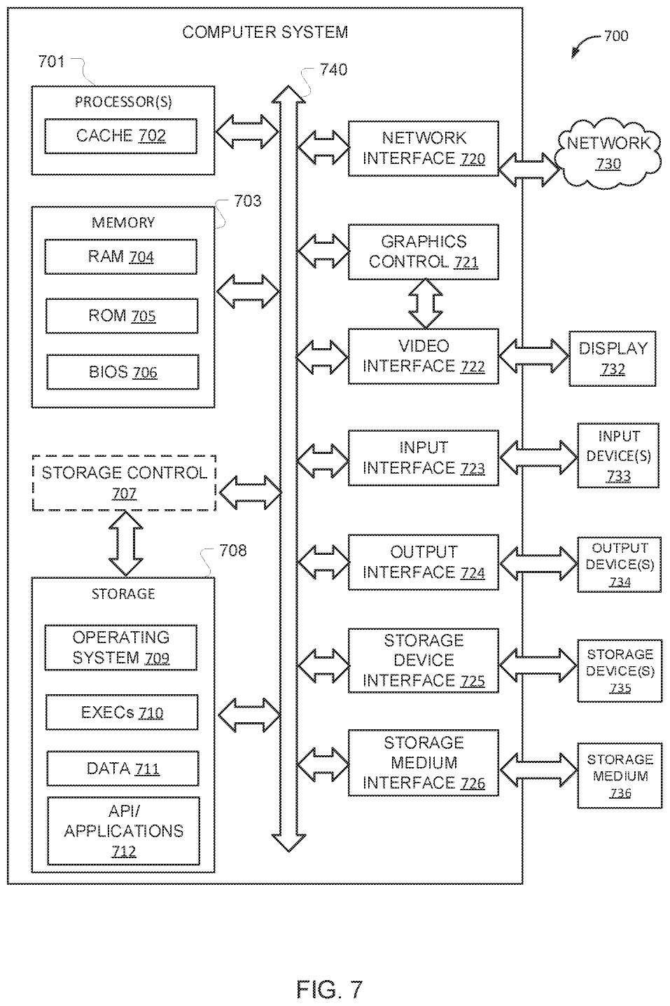

Referring to FIG. 7, it is a block diagram depicting an exemplary machine that includes a computer system 700 within which a set of instructions can execute for causing a device to perform or execute any one or more of the aspects and/or methodologies of the present disclosure. The components in FIG. 7 are examples only and do not limit the scope of use or functionality of any hardware, software, embedded logic component, or a combination of two or more such components implementing particular embodiments.

Computer system 700 may include a processor 701, a memory 703, and a storage 708 that communicate with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various tangible storage media 736. All of these elements may interface directly or via one or more interfaces or adaptors to the bus 740. For instance, the various tangible storage media 736 can interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 701 (or central processing unit(s) (CPU(s))) optionally contains a cache memory unit 702 for temporary local storage of instructions, data, or computer addresses. Processor(s) 701 are configured to assist in execution of computer readable instructions. Computer system 700 may provide functionality for the components depicted in FIGS. 1, 4, 5, and 6 as a result of the processor(s) 701 executing non-transitory, processor-executable instructions embodied in one or more tangible computer-readable storage media, such as memory 703, storage 708, storage devices 735, and/or storage medium 736. The computer-readable media may store software that implements particular embodiments, and processor(s) 701 may execute the software. Memory 703 may read the software from one or more other computer-readable media (such as mass storage device(s) 735, 736) or from one or more other sources through a suitable interface, such as network interface 720. The software may cause processor(s) 701 to carry out one or more processes or one or more steps of one or more processes described or illustrated herein. Carrying out such processes or steps may include defining data structures stored in memory 703 and modifying the data structures as directed by the software.

The memory 703 may include various components (e.g., machine readable media) including, but not limited to, a random-access memory component (e.g., RAM 704) (e.g., a static RAM “SRAM”, a dynamic RAM “DRAM, etc.), a read-only component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable tangible computer-readable media described below. In one example, a basic input/output system 706 (BIOS), including basic routines that help to transfer information between elements within computer system 700, such as during start-up, may be stored in the memory 703.

Fixed storage 708 is connected bidirectionally to processor(s) 701, optionally through storage control unit 707. Fixed storage 708 provides additional data storage capacity and may also include any suitable tangible computer-readable media described herein. Storage 708 may be used to store operating system 709, EXECs 710 (executables), data 711, API applications 712 (application programs), and the like. Often, although not always, storage 708 is a secondary storage medium (such as a hard disk) that is slower than primary storage (e.g., memory 703). Storage 708 can also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide nonvolatile and/or volatile storage of machine-readable instructions, data structures, program modules, and/or other data for the computer system 700. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730, computer system 700 may communicate with other devices, specifically mobile devices and enterprise systems, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 730, may employ a wired and/or a wireless mode of communication. In general, any network topology may be used.

Information and data can be displayed through a display 732. Examples of a display 732 include, but are not limited to, a liquid crystal display (LCD), an organic liquid crystal display (OLED), a cathode ray tube (CRT), a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721.

In addition to a display 732, computer system 700 may include one or more other peripheral output devices 734 including, but not limited to, an audio speaker, a printer, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition, or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for profile matching, the system comprising:
one or more hardware processors configured by machine-readable instructions to:
electronically receive, at one or more computer systems, a plurality of images from one or more sources;
electronically receive, via a first user device, a first request for profile matching from a first user;
display, on the first user device, at least a portion of the plurality of images, wherein the plurality of images are associated with one or more random categories;
receive, from the first user device, a first user input for at least the portion of the plurality of images, wherein the first user input comprises one or more first preference indications for at least the portion of the plurality of images;
compare, for at least the portion of the plurality of images, the one or more first preference indications to one or more second preference indications, the one or more second preference indications received from a second user device associated with a second user;
determine an overlap between the one or more first preference indications and the one or more second preference indications based at least in part on the comparing; and
in response to determining the overlap between the one or more first preference indications and the one or more second preference indications exceeds a threshold, automatically cause a graphical user interface associated with the first or the second user device to indicate a match between the first and the second user.

2. The system of claim 1, wherein the one or more hardware processors are further configured by machine-readable instructions to:
in response to determining the overlap between the one or more first preference indications and the one or more second preference indications does not exceed the threshold, compare the one or more first preference indications to one or more third preference indications, the one or more third preference indications received from a third user device associated with a third user;
determine an overlap between the one or more first preference indications and the one or more third preference indications based at least in part on the comparing;
in response to determining the overlap between the one or more first preference indications and the one or more third preference indications exceeds the threshold, automatically cause a graphical user interface associated with the first or the third user device to indicate a match between the first and the third user.

3. The system of claim 1, wherein the displaying comprises displaying one or more sets of images, at least one of the sets of images comprising two or more images;
wherein the two or more images are associated with a random category of the one or more random categories; and
wherein displaying a respective set of images is based at least in part on identifying that a first image from the respective set of images has not previously appeared against, been prioritized over, or a combination thereof, a second image from the respective set of images.

4. The system of claim 3, wherein the receiving the first user input comprises selecting, by the first user, a first image from a first set of images;
wherein the receiving the first user input comprises associating the selection of the first image with a first one of the first preference indications;
wherein the receiving the first user input comprises selecting, by the first user, a second image from a second set of images; and
wherein the receiving the first user input comprises associating the selection of the second image with a second one of the first preference indications.

5. The system of claim 4, wherein the one or more hardware processors are further configured by machine-readable instructions to:
increase a respective score value associated with the first and second images based in part on the selecting the first and second images respectively;
decrease a respective score value for at least one of the unselected images in the first and second sets of images.

6. The system of claim 4, wherein the one or more hardware processors are further configured by machine-readable instructions to:
store the first image and the second image in a prioritized image list based at least in part on the associating the selection of the first and second images respectively;
store a remainder of images from the first and the second set of images in a non-prioritized image list.

7. The system of claim 6, wherein prior to displaying at least the portion of the plurality of images;
wherein the one or more hardware processors are further configured by machine-readable instructions to determine if at least one image in the prioritized image list has been selected more than a threshold number of times;
wherein the at least one image in the prioritized image list no longer appears for selection based in part on the determining.

8. The system of claim 6, wherein prior to displaying at least the portion of the plurality of images;
wherein the one or more hardware processors are further configured by machine-readable instructions to determine if at least one image in the non-prioritized image list has been unselected more than a threshold number of times;
wherein the at least one image in the non-preferred image list no longer appears for selection based in part on the determining.

9. The system of claim 1, wherein the one or more hardware processors are further configured by machine-readable instructions to:
display, on a respective graphical user interface of the first or the second user device, a private message window for allowing one of the first or the second user to initiate contact with the other user via a direct message based at least in part on indicating the match between the first and the second user; or
display, on the graphical user interface of the first user device, a list of matched users associated with the first user including at least the second user and a third user;
and further display, on the graphical user interface of the first user device, a group message window for allowing the first user to initiate a group conversation with at least the second user and the third user.

10. The system of claim 1, wherein the one or more hardware processors are further configured by machine-readable instructions to:
display, on the graphical user interface of the first user device, a list of matched users associated with the first user;
automatically delete at least one matched user from the list of matched users based on determining an absence of communication between the at least one matched user and the first user, determining that a respective match value associated with the at least one matched user and the first user is under a match threshold value, or a combination thereof.

11. The system of claim 1, wherein the one or more hardware processors are further configured by machine-readable instructions to:
determine, for the first user, a total score for each image of the at least the portion of the plurality of images based in part on the first preference indications;
determine, for the second user, a total score for each image of the at least the portion of the plurality of images based in part on the second preference indications;
wherein determining the overlap between the first preference indications and the one or more second preference indications further comprises computing, using a matching algorithm, a match value for the first and second users, wherein the match value is based on determining respective total scores for each image of the at least the portion of the plurality of images.

12. A method of profile matching, the method comprising:
electronically receiving, at one or more computer systems, a plurality of images from one or more sources;
electronically receiving, via a first user device, a first request for profile matching from a first user;
displaying, on the first user device, at least a portion of the plurality of images, wherein the plurality of images are associated with one or more random categories;
receiving, from the first user device, a first user input for at least the portion of the plurality of images, wherein the first user input comprises one or more first preference indications for at least the portion of the plurality of images;
comparing, for at least the portion of the plurality of images, the one or more first preference indications to one or more second preference indications, the one or more second preference indications received from a second user device associated with a second user;
determining an overlap between the one or more first preference indications and the one or more second preference indications based at least in part on the comparing; and
in response to determining the overlap between the one or more first preference indications and the one or more second preference indications exceeds a threshold, automatically causing a graphical user interface associated with the first or the second user device to indicate a match between the first and the second user.

13. The method of claim 12, further comprising:
in response to determining the overlap between the one or more first preference indications and the one or more second preference indications does not exceed the threshold, comparing the one or more first preference indications to one or more third preference indications, the one or more third preference indications received from a third user device associated with a third user;
determining an overlap between the one or more first preference indications and the one or more third preference indications based at least in part on the comparing; and
in response to determining the overlap between the one or more first preference indications and the one or more third preference indications exceeds the threshold, automatically causing a graphical user interface associated with the first or the third user device to indicate a match between the first and the third user.

14. The method of claim 12, wherein the displaying comprises displaying one or more sets of images, at least one of the sets of images comprising two or more images, wherein the two or more images are associated with a random category of the one or more random categories; and
wherein displaying a respective set of images is based at least in part on identifying that a first image from the respective set of images has not previously appeared against, been prioritized over, or a combination thereof, a second image from the respective set of images.

15. The method of claim 14, wherein the receiving the first user input comprises selecting, by the first user, a first image from a first set of images;
wherein the receiving the first user input comprises associating the selection of the first image with a first one of the first preference indications;
wherein the receiving the first user input comprises selecting, by the first user, a second image from a second set of images; and
wherein the receiving the first user input comprises associating the selection of the second image with a second one of the first preference indications.

16. The method of claim 15, further comprising:
increasing a respective score value associated with the first and second images based in part on the selecting the first and second images respectively; and
decreasing a respective score value for at least one of the unselected images in the first and second sets of images.

17. The method of claim 15, further comprising:
storing the first image and the second image in a prioritized image list based at least in part on the associating the selection of the first and second images respectively; and
storing a remainder of images from the first and the second set of images in a non-prioritized image list.

18. The method of claim 17, wherein prior to displaying at least the portion of the plurality of images;
determining if at least one image in the prioritized image list has been selected more than a threshold number of times; and
wherein the at least one image in the prioritized image list no longer appears for selection based in part on the determining.

19. The method of claim 17, wherein prior to displaying at least the portion of the plurality of images;
determining if at least one image in the non-prioritized image list has been unselected more than a threshold number of times; and
wherein the at least one image in the non-preferred image list no longer appears for selection based in part on the determining.

20. The method of claim 12, further comprising:
displaying, on a respective graphical user interface of the first or the second user device, a private message window for allowing one of the first or the second user to initiate contact with the other user via a direct message based at least in part on indicating the match between the first and the second user; or
displaying, on the graphical user interface of the first user device, a list of matched users associated with the first user including at least the second user and a third user; and
further displaying, on the graphical user interface of the first user device, a group message window for allowing the first user to initiate a group conversation with at least the second user and the third user.

21-35. (canceled)
